(19) United States
(12) Patent Application Publication
(10) Pub. No.: US 2018/0175653 A1
(43) Pub. Date: Jun. 21, 2018

(54) WIRELESS CHARGER

(71) Applicant: Black & Decker Inc., New Britain, CT (US)

(72) Inventors: Tylan A. Tschopp, Baltimore, MD (US); Crispin Catherwood, Slough (GB)

(21) Appl. No.: 15/386,390

(22) Filed: Dec. 21, 2016

(51) Int. Cl. H02J 7/02; B25F 5/00

(52) U.S. Cl. CPC H02J 7/025; B25F 5/00

(57) ABSTRACT

A power tool system includes a power tool, a power tool battery pack and a wireless charger for charging an electronic device. The power tool battery pack is separable from and attachable to the power tool, and electrically connectable to the power tool electrical terminals when attached to the power tool. The battery pack charger is connectable to the power tool battery pack and has at least one transmitter coil for generating a magnetic field which induces a voltage in a receiver coil of the electronic device, and a control circuit for controlling the amount of power that is provided to the transmitter coil.

### FIELD OF THE INVENTION

The present invention relates to wireless chargers.

### BACKGROUND

It is desirable to rapidly and efficiently charge electronic devices. One common solution has been to use wireless chargers, using inductive charging technology. Several standards exist for such technology, including the Qi standard developed by the Wireless Power Consortium and the PMA standard developed by the Powers Matters Alliance. These wireless chargers can charge compatible electric and electronic devices.

However, such wireless chargers may not be portable as they typically have to be connected to a power outlet. Accordingly, they cannot be used in areas without nearby power outlets.

It is an object of this invention to provide a wireless chargers that can charge compatible devices without nearby power outlets.

### BRIEF DESCRIPTION OF THE DRAWINGS

FIG. 1 is a perspective view of the wireless charger.

FIG. 2 is a circuit schematic of some of the components of the wireless charger.

FIG. 3 is a circuit schematic of some of the components of the electronic device to be charged by the wireless charger.

### DESCRIPTION

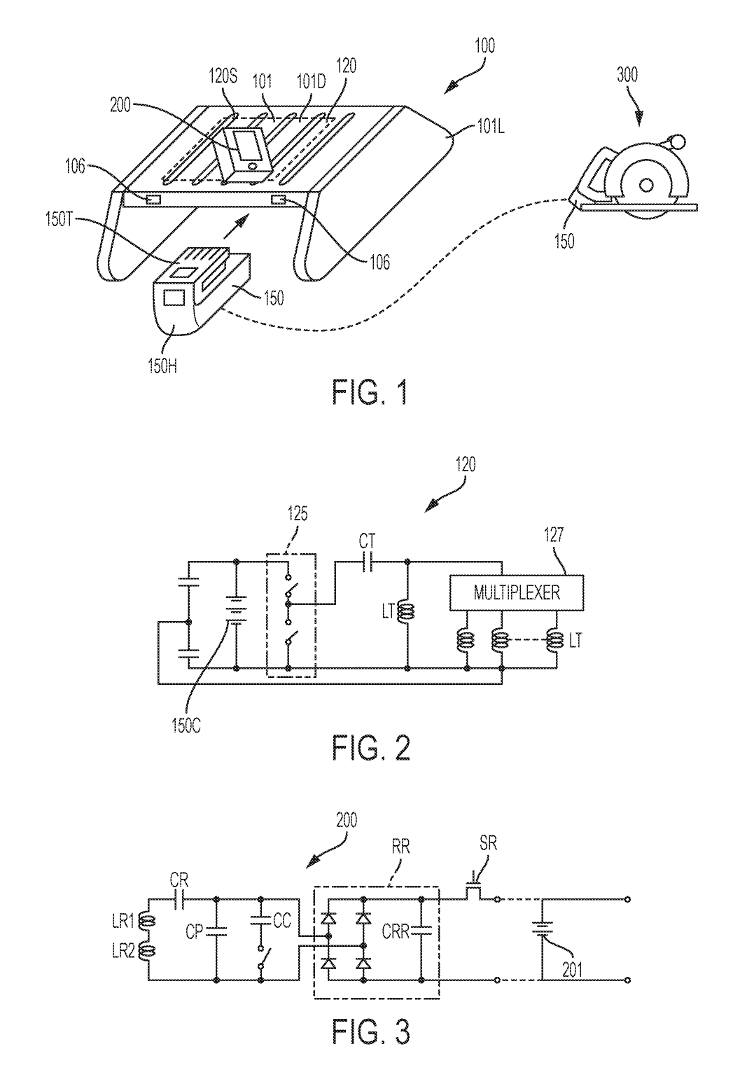

FIG. 1 shows a wireless charger 100 for charging electronic devices 200, such as smartphones, tablets, etc. The wireless charger 100 has a housing 101 with a deck 101D where a user can place electronic device 200. Deck 101D may have several wireless charging circuits 120, which are described in more detail below, allowing multiple electronic devices 200 to be charged at the same time.

Power for the wireless charging circuit(s) 120 may be received from a power tool battery pack 150, which is mechanically engaged to wireless charger 100 and electrically connected to the wireless charging circuit(s) 120. Persons skilled in the art shall understand that “battery pack” and “power tool battery pack” as used herein shall mean a set of rechargeable battery cells 150C (FIG. 2) disposed in a housing 150H that is electrically connectable to and for use with a tool that is powered by an electrical motor, such as a circular saw 300, drill, reciprocating saw, jigsaw, etc. Persons skilled in the art shall recognize that power tool battery pack 150 may be the power tool battery packs disclosed in U.S. Pat. Nos. 7,405,536, 7,618,741, 7,602,146 and/or 8,044,640, which are hereby incorporated in full by reference. With such construction, the user can slide in battery pack 150 and electrically connect to the wireless charger 100 (and the power tool, e.g., circular saw 300) via terminals 150T.

Persons skilled in the art will recognize that the different wireless charging circuits 120 can be controlled so that (a) only one electronic device 200 is charged at a time (once the electronic device 200 is charged, the next electronic device pack 200 can be charged), (b) each electronic device 200 is charged concurrently, and/or (c) the user can choose the order in which the electronic devices 200 are charged (or the user can choose to charge all electronic devices 200 at the same time).

Deck 101D preferably has indicator lights 106 right underneath electronic device(s) 200 showing the charging status of the electronic device(s) 200 thereabove. It may be advantageous to provide deck 101D with anti-slip strips 120S.

Support structures or legs 101L may be connected to deck 101D for elevating deck 101D, allowing the user to connect battery pack 150 underneath deck 101D.

Referring to FIGS. 1-3, the wireless charger circuit 120 preferably has at least one transmitter coil LT, while the electronic device 200 has at least one receiver coil LR. An alternating current in the transmitter coil LT generates a magnetic field which induces a voltage in the receiver coil LR. This voltage is used to charge electronic device 200.

Persons skilled in the art will recognize that the wireless charger circuit 120 could have multiple transmitter coils LT. Alternatively it could have a moving transmitter coil LT so that, when the electronic device 200 is placed on wireless charger circuit 120, transmitter coil LT moves towards electronic device 200. Persons skilled in the art will recognize that electronic device 200 may have a magnet (not shown) that is used by wireless charger circuit 120 to locate the location of electronic device 200, and move transmitter coil LT via servo motors (not shown) towards electronic device 200.

Preferably the electronic device 200 has a control circuit 202, which controls the amount of power sent to the cells 201. Control circuit 202 interacts with microcontroller 202C to ensure that cells 201 are not overcharged.

Electronic device 200 may also have a communication circuit 203 that provides control information to the wireless charger circuit 120. Communication circuit 203 may send the control information by modulating a reflected load signal 203S. This information would be received by a communication circuit 122 on the wireless charger circuit 120, which demodulates the information from the reflected load signal 203S.

The wireless charger circuit 120 preferably has a control circuit 124 that controls the amount of power to be converted and transmitted to the electronic device 200. Control circuit 124 can take into account the information sent by control circuit 202 via the communication circuits 203, 122, and adjust the amount of power transmitted to electronic device 200.

The wireless charger circuit 120 has a power conversion circuit 126 with a transmitter coil LT and a resonance capacitor CT in series with the transmitter coil LT. Power provided by cells 150C may may be converted by a half bridge inverter 125 connected to the inductor/capacitor series circuit. Persons skilled in the art shall know that it may be preferable to provide an impedance matching system by adding a multiplexer 127 and multiple additional transmitter coils LT to the wireless charger circuit 120 as shown in FIG. 2.

The electronic device 200 may have a receiver coil(s) LR (LR1, LR2) with a resonance capacitor CR in series with receiver coil(s) LR (LR1, LR2) for efficient power transfer. In addition, a capacitor CP in parallel with receiver coil LR (and resonance capacitor CR) can be used for detection purposes.

A full-bridge rectifier RR is preferably connected to the receiver coil LR and capacitors. Rectifier RR may be a diode rectifier or switched rectifier. Persons skilled in the art will recognize that it is preferable to provide rectifier RR with a capacitor CRR to smooth the DC voltage output.

A switch SR may be provided on the output of rectifier RR for connecting and disconnecting the battery cells 201. Switch SR may be controlled by control circuit 202 and/or microcontroller 202C.

Persons skilled in the art will recognize that electronic device 200 can modulate the reflected load signal 203S by switching capacitor CC, which is preferably controlled by communication circuit 203. This reflected load signal 203S can be demodulated by sensing the current and/or voltage going through transmitter coil LT. Preferably the modulation will be in a digital format with a transmission speed of 2 Kbit/second. Bit encoding is preferably bi-phase. The byte format may be as follows: start-bit, 8 bit data (b0-b7), parity-bit, stop bit. The packet structure may be as follows: preamble (>=11 bit), header (1 byte indicating packet type and message length), message (up to 27 bytes), and checksum (1 byte).

With such arrangement, the wireless charger circuit 120 can provide a signal and sense for the presence of a potential receiver. The electronic device 200 receives the signal from wireless charger circuit 120 and indicates its presence by communicating the received signal strength. The electronic device 200 can then communicate its identifier and power requirements. The wireless charger circuit 120 can use that information to configure itself for transferring power to the electronic device 200.

Once power is being transferred to electronic device 200, the control circuit 202 and/or microcontroller 202C can calculate the difference between a desired power level being sent to the electronic device 200 and the actual power level being sent to the electronic device 200. The communication circuit 203 can then send a message to the wireless charger circuit 120 effectively telling the wireless charger circuit 120 to increase or decrease the amount of power being sent to the electronic device 200. The wireless charger circuit 120 can decode the message and configure itself accordingly.

The description of the invention is merely exemplary in nature and, thus, variations that do not depart from the gist of the invention are intended to be within the scope of the invention. Such variations are not to be regarded as a departure from the scope of the invention.

What is claimed is:

1: A power tool system comprising:
a power tool having a housing and electrical terminals disposed within the power tool;
a power tool battery pack separable from and attachable to the power tool housing, the power tool battery pack being electrically connectable to the power tool electrical terminals when attached to the power tool; and
a wireless charger for charging an electronic device, the wireless charger being connectable to the power tool battery pack and comprising at least one transmitter coil for generating a magnetic field which induces a voltage in a receiver coil within the electronic device, and a control circuit for controlling the amount of power that is provided to the transmitter coil.

2: The power tool system of claim 1, wherein the power tool is at least one of the group consisting of a drill, a circular saw, a reciprocating saw and a jigsaw.

3: The power tool system of claim 1, wherein the electronic device has a communication circuit providing control information to the wireless charger control circuit.

4: The power tool system of claim 3, wherein the wireless charger has a communication circuit that receives information from the electronic device communication circuit.

5: The power tool system of claim 4, wherein the wireless charger communication circuit demodulates control information from a modulated load signal.
